(19) United States
(12) Patent Application Publication
(10) Pub. No.: US 2008/0295356 A1
(43) Pub. Date: Dec. 4, 2008

(54) Indirectly heated screw processor apparatus and methods

(75) Inventor: Robert D. Nickerson, Vallejo, CA (US)

Correspondence Address: K. Brian Matlockn at Matlock Law Group, P.C, Suite 200, 1485 Treat Blvd., Walnut Creek, CA, 94597, US

(73) Assignee: Therma-Flite, Inc., Benicia, CA (US)

(21) Appl. No.: 12/156,681

(22) Filed: Jun. 2, 2008

Related U.S. Application Data
(60) Provisional application No. 60/932,808, filed on Jun. 2, 2007.

(51) Int. Cl. F26B 3/24; F01D 5/08; F26B 11/12

(52) U.S. Cl. 34/519; 416/96 R; 34/179

(57) ABSTRACT

A new Indirectly Heated Screw Processor Apparatus and Methods wherein a series of rotating helical ducts or hollow flites radial to a shaft, transfers heat via a heat transfer medium, the first face flite disc facing in the opposite direction to material or product flow and thereby significantly increasing the product retention time and thermal heat transfer. Heat is transferred via a heat transfer medium through a rotary joint to the inner surface of the hollow shaft. The flites continuously traverse a longitudinal portion of the rotor wherein said flites are equally spaced apart in a substantially parallel angle and orientation, the spacing, or pitch, concluding in a non-flite, or “dead zone” region of the longitudinal length of rotor wherein the material or product accumulates and is retained for an increased amount of time, and when compared to conventional indirect-heating screw conveyors, the apparatus provides a higher percentage of flite height fill.

### CROSS-REFERENCES TO RELATED APPLICATIONS

This application claims the benefit of U.S. Provisional Application Ser. No. 60/932,808 (Attorney docket No. 035TFL-001), filed 02 Jun. 2007, the disclosure of which is incorporated herein by reference in its entirety.

### BACKGROUND

The present invention relates generally to a heat exchanger, an indirectly-heated screw processing apparatus and more specifically to a helical blade mixing and/or conveying apparatus having a series of hollow blades mounted on a rotor which functions in some configurations as a material conveyer but more typically functions as a heat exchange processor and provides for heating or in general to effect a thermal treatment such as drying, evaporation, calcinations and crystallization of the product fed into the apparatus. The present invention also relates to a system and method for processing materials in a screw-type heat exchanger.

Conventionally screw-type heat exchangers are made from pairs of ring shaped discs welded together, one disc being shaped with its inner diameter curved into or nearly into the axial direction and the other disc being welded to the first disc at its inner and outer diameters. The blade between its ends may be welded directly to the rotor or may run freely on the rotor to allow for expansion and contraction. “In some embodiments, the blade between its ends, typically called a pad, is welded to the first and second disk (or flites) so that the helical duct can expand and contract separately from the rotor shaft (or stem pipe).”

In some designs, a conventional hollow flite apparatus may include two or more rotors each carrying a helical, continuous blade or flite, the two blades or flites being intermeshed with each other so that the outer diameter of each solid blade is spaced a short distance from the opposite rotor. Screw shafts of the conventional apparatus are substantially circular in cross-section and substantially symmetrical about a substantially centered longitudinal rotational axis. In some conventional designs, the larger diameter screw shafts are double-walled for at least a portion of their length outside of the screw shaft bearing areas. However, such designs do not provide the fill heights necessary to provide increased volume reduction in a reduced space requirement.

One drawback to conventional designs occurs during drying operations. As a material dries it loses volume. In a design with fixed-pitch or the same distance between every flite, the material loses thermal contact with the flites as the material dries and shrinks. Also conventional blade shapes or geometries do not provide a high degree of thermal transfer efficiency. Therefore, what is needed is a new indirectly heated screw processor apparatus and methods.

### SUMMARY OF THE INVENTION

One object of an embodiment is to improve the heat transfer capacity and efficiency of the mixing, heating and in general improve heat transfer in the aforesaid thermal treatments.

Another object of one embodiment is to increase the volume reduction of a plurality of semisolid, liquid mixtures of material, or product, said material or product including soils, sludges, slurries, or other particulate or granular materials by decreasing the volume capacity or pitch at each stage of the rotor in conjunction with the volume reduction of the process material or product, increasing the “loading capacity” and utilizing the maximum amount of heat transfer surface through the full length of the apparatus. In certain aspects, it is an object of the embodiment to increase the rate of the drying process.

Yet another object of an embodiment is a method to provide an increased retention time for product as it moves through a rotor and stages or accumulates in certain zones of the rotor in the indirect-heating screw conveyer apparatus.

Another object of an embodiment is to provide a maximum efficiency and an improvement in heat transfer in a minimum amount of volume or space by decreasing the volume capacity or pitch at each stage of the rotor in conjunction with the volume reduction of the process material or product, increasing the “loading capacity” and utilizing the maximum amount of heat transfer surface through the full length of the apparatus.

In one embodiment, an apparatus relates to a new type of screw heat exchanger. In certain aspects, an indirectly heated screw processor apparatus comprises a series of rotating helical ducts or hollow flites that are radial to a rotor and transfers heat via a heat transfer medium. The hollow flites exterior surface are comprised of a first and second disc or flite wherein the second disk having its outer edge curved toward the first disc and facing in the direction to material or product flow significantly increases thermal heat transfer. Heat is transferred via a heat transfer medium, for example hot oil or a comparable medium such as steam or hot water or hot air. From a pump through a rotary joint, the heat transfer medium flows through the inner surface of the hollow shaft. The hollow helical duct or hollow flite is constructed of a pair of helically shaped first and second discs, wherein the first disc is substantially radial to the shaft, the second disc is welded to the rotor at its inner edge and its outer edge or diameter is curved towards the first disc and welded to the outer diameter of the first disc such that nearly all of the remainder of the second disc is substantially radial to the shaft. The discs are spaced apart between the inner and outer edges to form a single continuous space or duct extending helically around the rotor and through which the heat transfer medium can flow through the hollow flite. The flites continuously traverse a longitudinal portion of the rotor in stages wherein the flites are equally spaced apart in a substantially parallel angle and orientation, the spacing, or pitch, concluding in a non-flite, or “dead zone” region of the longitudinal length of the rotor wherein the material or product accumulates then continue to the next stage wherein the spacing, or pitch is of a reduced proportion, concluding in a non-flite, or “dead zone” region and will be retained for an increased amount of time when compared to conventional indirect-heating screw conveyor apparatus.

In certain longitudinal areas of the first embodiment, there are non-flite zones with mixing blades or tabs having curved inner diameters spaced from the shafts where the product tends to accumulate through the spaces between the blades or flites of the rotors to produce a very efficient mixing and heating of the product.

Another embodiment of the indirectly-heated screw processor apparatus comprises such an apparatus wherein a series of rotating helical ducts or hollow flites radial to a shaft, transfers heat via a heat exchange agent that includes multiple stage flite sections followed by non-flite or “dead zone” areas where a through-hole port from one stage flows into the single continuous annular space wherein a heat transfer medium travels through the port, entering the one stage single continuous helical duct and traverses the length of the non-flite or “dead zone” rotor until exiting an exit through-hole port into the next stage continuous helical duct of reduced pitch. The flites continuously traverse a longitudinal portion of the rotor wherein the flites are equally spaced apart in a substantially parallel angle and orientation, the spacing, or pitch, concluding in a non-flite, or “dead zone” region of the longitudinal length of the rotor wherein the material or product accumulates and will be retained for an increased amount of time when compared to conventional indirect-heating screw conveyor apparatus.

In certain aspects of the first embodiment, an apparatus with dead zones A and B have a determined length between a first flite zone A, a second flite zone B, and a third flite zone C, with respect to traversing the length of the rotor. In order to maximize the efficiency of the apparatus, the spacing or pitch of each flite zone must correspond to the material characteristics and more specifically the volume reduction characteristics of the process material to avoid a significant reduction in usable heat transfer surface area through the process. Further, to offset harmful temperature fluctuations in the flite, a pad is affixed underneath the face and the back flite without any gap. The first and second flites or discs rest substantially radial to the shaft. The pads provide a helical duct in which the duct is not attached (or welded directly to the rotor (or “stem pipe”). This configuration allows the duct to expand and contract separately from the “stem pipe” causing less stress in the welds of the flights due to temperature fluctuations, and less potential of cracking or failure of welds to occur.

Another embodiment of the screw heat exchange rotor may comprise a plurality of helical discs, a shaft, an entry port, an exit port, a mounting pad and a heat, transfer medium, wherein the screw heat exchanger rotor is double walled and a hollow helical duct is mounted on and surrounding the shafts. The hollow helical duct is made of pairs of helically shaped split discs wherein the first disc of each pair is substantially radial to the shaft, and the second disc is welded to the rotor at its inner edge. The second disc's outer surface is curved towards the first disc and welded thereto at an outer diameter of the first disc such that substantially all of the remainder of the second disc is substantially radial to the shaft. The curved outer surface is oriented facing axially to the longitudinal direction of material flow, the discs spaced apart between the inner and outer edges to form a single continuous duct extending helically around the rotor and longitudinally along a rotor length, through which a heat transfer medium can flow within the hollow duct.

Another embodiment of the attached disclosure includes a rotating processor rotor assembly comprising a plurality of flite sections, each flite section having a different pitch from other flite sections, wherein the pitch comprises the distance between flites. The flites are spaced along the rotor assembly in a consistently spaced pitch. The dead-zone sections are typically spaced along the rotor assembly separated by successive flite sections of different pitch. The dead-zone sections are devoid of flites and are separated from other flite sections. The dead zone sections are typically spaced apart equally. The “dead” zone section is devoid of flites and contains tabs spaced radially about the circumference of the rotor assembly and spaced longitudinally about a length not to exceed the dead-zone space. In other certain aspects of the embodiment, the tabs are equidistant from a point about a centerline through a shaft of the rotor assembly and extending radially therefrom, said tabs oriented at a substantially perpendicular angle from the rotor assembly surface, said tabs located up to 90 degrees off from the previous tab.

In another embodiment, one method of drying a material or product includes applying the material to a first end of a first screw heat exchanger rotor, the rotor having a plurality of flites, each flite section having a different pitch that the other zones, rotating the rotor such that the material is propelled along the shaft, heating the rotor by passing a heat transfer medium through a portion of the rotor. The material is applied in a manner so that the material is conveyed in a direction opposite the orientation of said first and second discs welded together in a flite assembly, wherein said applying the material increases heat transfer rates in the direction of material flow opposite to said first and second discs flite assembly.

Another method of drying a material or product includes applying the material to a first end of a second screw heat exchange shaft, the rotor being positioned on close proximity to the first heat exchanger rotor such that the flites intermesh, rotating the second rotor such that the material is propelled along the shaft, heating the flites by having the heat transfer medium flow through a hollow blade in each flite and applying the material through one or more flite sections and one or more dead-zones wherein said flite assemblies are not present but communicator non-flite dead zone tabs, located up to ninety degrees apart, are present to agitate the material.

In another embodiment, the indirect heated screw processor apparatus and methods may also be included as part of a heat transfer processing system. The system may variously include a hopper or bin designed to temporarily hold materials prior to processing wherein the materials are homogenized and continuously fed onto a transfer conveyor, one or more rotating screw heat exchange rotors having a plurality of flite sections, each flite section having a different pitch from other flite sections, wherein the pitch encompasses the distance between flites in a given section. The flites are disposed along the rotor in a consistently spaced pitch with a dead-zone sections wherein the flites are no longer spaced apart in a consistent pitch, the dead-zone sections comprising no flites and separated from other flites spaced apart in an equal but different pitch, the second and subsequent pitch to create alternating zones of equal pitches and a “dead” zone area devoid of flites. Tabs in the dead-zone are disposed radially to a length not exceeding the dead-zone space, the tabs spaced up to 90 degrees off from the previous tab and equidistant from a point about a centerline through said shaft. Further, the system may include a device wherein the temperature of a heat exchange medium is increased and passed through a portion of the rotor or hollow blade in the flites, an discharge conveyor for dry material discharge, a cylindrical chamber that has at least one outlet through which exhaust is released, a panel from which the system can be controlled including automated safety sensors and a device for reducing gasses or vapors to liquid or solid form.

Another embodiment of the system may include a hopper or bin designed to temporarily hold materials prior to processing wherein the materials are homogenized and continuously fed into onto a transfer conveyor, at least one rotating screw heat exchange rotor having a plurality of flite sections, each flite section having a different pitch from other flite sections, wherein the pitch encompasses the distance between flites. In certain aspects, an indirectly heated screw processor apparatus comprises a series of rotating helical ducts or hollow flites that are radial to a rotor and transfers heat via a heat transfer medium. The hollow flites exterior surface are comprised of a first and second disc or flite wherein the second disk having its outer edge curved toward the first disc and facing in the direction to material or product flow significantly increases thermal heat transfer. Heat is transferred via a heat transfer medium, for example hot oil or a comparable medium such as steam or hot water or hot air. From a pump through a rotary joint, the heat transfer medium flows through the inner surface of the hollow shaft. The hollow helical duct or hollow flite is constructed of a pair of helically shaped first and second discs, wherein the first disc is substantially radial to the shaft, the second disc is welded to the rotor at its inner edge and its outer edge or diameter is curved towards the first disc and welded to the outer diameter of the first disc such that nearly all of the remainder of the second disc is substantially radial to the shaft. The discs are spaced apart between the inner and outer edges to form a single continuous space or duct extending helically around the rotor and through which the heat transfer medium can flow through the hollow flite. The flites continuously traverse a longitudinal portion of the rotor in stages wherein the flites are equally spaced apart in a substantially parallel angle and orientation, the spacing, or pitch, concluding in a non-flite, or “dead zone” region of the longitudinal length of the rotor wherein the material or product accumulates then continue to the next stage wherein the spacing, or pitch is of a reduced proportion, concluding in a non-flite, or “dead zone” region and will be retained for an increased amount of time when compared to conventional indirect-heating screw conveyor apparatus. Further, the system may include a device wherein the temperature of a heat exchange medium is increased and passed through a portion of the rotor or hollow blade in the flites, a discharge conveyor for dry material discharge, a cylindrical chamber that has at least one outlet through which exhaust is released, a panel from which the system can be controlled including automated safety sensors and a device for reducing gasses or vapors to liquid or solid form. Several heat exchange shafts may then be arranged in space saving tiered units wherein heat sensitive products can be introduced into each tier individually at the desired temperature in order to avoid undesired chemical reactions.

In certain aspects of a system embodiment, an indirectly heated screw processor apparatus, comprises a housing; at least one double-walled screw shaft; and a hollow helical duct mounted on and surrounding said rotors, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the shaft, said curved disk oriented facing the direction of material flow, said discs spaced apart between said inner and outer edges to form a single continuous duct extending helically around the rotor and longitudinally along a rotor length, through which a heat transfer medium can flow within the hollow duct.

In other various aspects of an indirectly heated screw processor apparatus embodiment, one or more through-hole ports into the single continuous space wherein a heat transfer medium enters through said port, entering said single continuous helical duct and traversing the length of the rotor until exiting one or more through-hole ports per flite section.

In other various aspects of an indirectly heated screw processor apparatus embodiment, a pad upon which said first and second discs rest substantially radial to the shaft.

In another embodiment, a screw heat exchange rotor, comprises a plurality of helical discs; a shaft; an entry port; an exit port; a mounting pad; and a heat transfer medium, wherein said screw heat exchange rotor is double walled and a hollow helical duct is mounted on and surrounding said rotor, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the rotor, said curved outer disk oriented facing the direction of material flow, said discs spaced apart between said inner and outer diameters to form a single continuous duct extending helically around the rotor and longitudinally along a rotor length, through which a heat transfer medium can flow within the hollow duct.

In another embodiment, a rotating rotor assembly comprises a plurality of flite sections, each flite section having a different pitch from the previous flite section, wherein said pitch comprises the distance between flites, said flites being spaced along the rotor assembly in a consistently spaced pitch; one or more dead-zone spaces wherein said dead-zone sections are devoid of flites and are separated from other flite sections with a different pitch, said other pitch sections creating differing pitch sections and one or more “dead” zone sections; and one or more tabs in said dead-zone sections extending radially and longitudinally to a length not to exceed the dead-zone section wherein some tabs are 90 degrees off from the previous tab, said tabs mounted equidistant from a point about a centerline through said shaft.

In another embodiment, a multiple rotor heat exchange device comprises a housing, and a plurality of heat exchange rotors, each rotor having a plurality of flites, each flite having a different pitch, wherein each of the heat exchange shafts are positioned together such that adjacent flites intermesh, thereby increasing heat transfer rates and heat transfer capacities.

In another embodiment, a method of drying a material comprises the following steps in any order: applying the material to a first end of a first screw heat exchange rotor, said rotor having a plurality of flite sections, each flite section having a different pitch than the other flite sections; rotating the rotor such that a material is conveyed along the rotor; heating the rotor by passing a heat transfer medium through a portion of the rotor; and applying the material in a direction opposite the orientation of said first and second discs welded together in a flite assembly, wherein said applying the material increases heat transfer rates in the direction of material flow opposite to said first and second discs flite assembly, wherein said flite assembly comprises a back flite and a face flite, and wherein said back flite is facing the direction of material flow.

In certain aspects of the previous embodiment, the method further includes the steps of providing a second heat exchange rotor; applying the material to a first end of a second heat exchange rotor, said rotor being positioned in close proximity to the first heat exchange rotor such that the flites intermesh; heating the flites by having the heat transfer medium flow through a hollow flite assembly; rotating the second rotor; and applying the material through one or more flite sections and one or more dead-zones wherein said flite assemblies are not present but communicator non-flite dead zone tabs, ninety-degrees apart, are present to agitate said material.

In another embodiment, a system for drying material comprises a bin designed to temporarily hold material prior to processing wherein said materials are homogenised and continuously fed onto a transfer conveyor; at least one indirectly heated screw processor rotor having a plurality of flite sections, each flite section having a different pitch from other flite sections, wherein said pitch comprises the distance between flites, said flites being spaced along the rotor in a consistently spaced pitch; a dead-zone space wherein said flites are no longer spaced apart in a consistent pitch, said dead-zone space comprising no flites and separated from other flites spaced apart in an equal but different pitch, said second and subsequent pitch to create alternating zones of equal pitches and a “dead” zone area devoid of flites, and tabs in said dead-zone disposed radially to a length not to exceed the dead-zone space, said tabs spaced 90 degrees off from the previous tab, said tabs equidistant from a point about a centerline through said shaft; a hollow helical duct mounted on and surrounding said rotors, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the shaft, said curved disk oriented facing the direction of material flow, said discs spaced apart between said inner and outer edges to form a single continuous duct extending helically around the rotor and longitudinally along a rotor length, through which a heat transfer medium can flow within the hollow duct, a device wherein the temperature of a heat exchange medium is increased and passed through a portion of said rotor or hollow blade in said flites; an exit port conveyor for dry material discharge; a cylindrical chamber having at least one outlet through which exhaust is released; a panel from which the system can be controlled including automated safety sensors; and a device for reducing gases or vapors to liquid or solid form in one or more scrubber design configurations.

In certain aspects of the embodiment, the system further includes at least one rotating screw heat exchange rotor having a plurality of flites, each flite having a different pitch from other flite sections, wherein said pitch comprises the distance between flites, said flites being spaced along the rotor in a consistently spaced pitch; a dead-zone space wherein said flites are no longer spaced apart in a consistent pitch but is devoid of flites, said dead-zone space comprising no flites and separated from other flite sections spaced apart in an equal but different pitch, said second and subsequent pitch to create different pitches and tabs in said dead-zone configured longitudinally to a length not to exceed the dead-zone space, said tabs spaced 90 degrees off from the previous tab, said tabs equidistant from a point about a centerline through said rotor; wherein the rotating heat exchange rotors are arranged in space saving tiered units; and wherein heat sensitive products can be introduced into each tier individually at the desired temperature in order to avoid undesired chemical reactions.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a indirectly heated screw processor flite assembly in a cross-section view according to one aspect of an embodiment.

FIG. 2 shows another embodiment of a indirectly-heated screw processor apparatus.

FIG. 3 illustrates the heat transfer medium fluid flow in an indirectly heated screw processor apparatus

FIG. 4 illustrates another embodiment of the indirectly heated screw processor apparatus using a dual screw-type heat exchanger design.

FIG. 5 illustrates one method of drying material using another embodiment of the screw-type heat exchanger This system include a hopper, feed screw, dryer, condenser, cooling screw, thermal fluid heater, and central control panel.

FIG. 6 is a flow diagram showing a method for applying material in an indirectly heated screw processor.

FIG. 7 is a flow diagram showing a method for applying material in an indirectly heated, multiple rotor screw processor.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

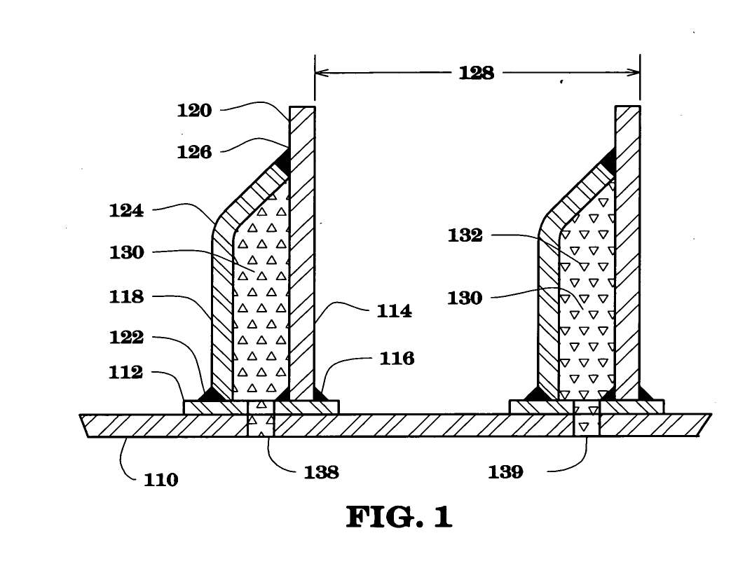

FIG. 1 illustrates an indirectly heated screw processor flite assembly in a cross-section view according to one aspect of an embodiment. A screw flite is the helical thread or raised portion of a screw. For the purpose of this invention a screw flite is any raised portion either partially, completely or repeatedly turned around a central shaft, rod or rotor. In FIG. 1 the stem pipe 110 supports a pad 112. Affixed to the pad 112 is a face flite 114 mounted substantially radially to the stem pipe 110 such that the flite 114 has a inner diameter 116 attached to the pad 112 and 120. A back flite 118 is attached to the pad 112 such that the flite is radial to the stem pipe 110 at an inner diameter 122 and shaped in an axial direction 124 near an outer diameter 126 such that the outer diameter 126 connects to the face flite 114 at or near the outer diameter 120 of the face flite 114, leaving a small portion of the face flite 114 extending beyond the outer diameter 126 of the back flite 118. The face flite 114 and the back flite 118 are spaced apart to form a single contiguous cavity 130 or duct extending helically around the stem pipe 110 through which a heat transfer medium 132 can flow and the inner and outer walls of said flites spaced longitudinally about said axis to form a distance, or pitch 128, between substantially parallel flites.

Multiple flites are constructed at a predetermined distance or pitch 128 such that a corresponding rotor segment comprises a plurality of flites of the same pitch 128. A stem pipe segment may have a entry 138 and exit 139 ports and designed to fully fill the cavity under pressure, allowing the heat exchange medium to pass in and out of the cavity in the flite.

One having skill in the art will recognize that the screw flite 100 may be made of a multiplicity of metals and welded together or formed from other materials such that the essential shape and thermal exchange property are realized.

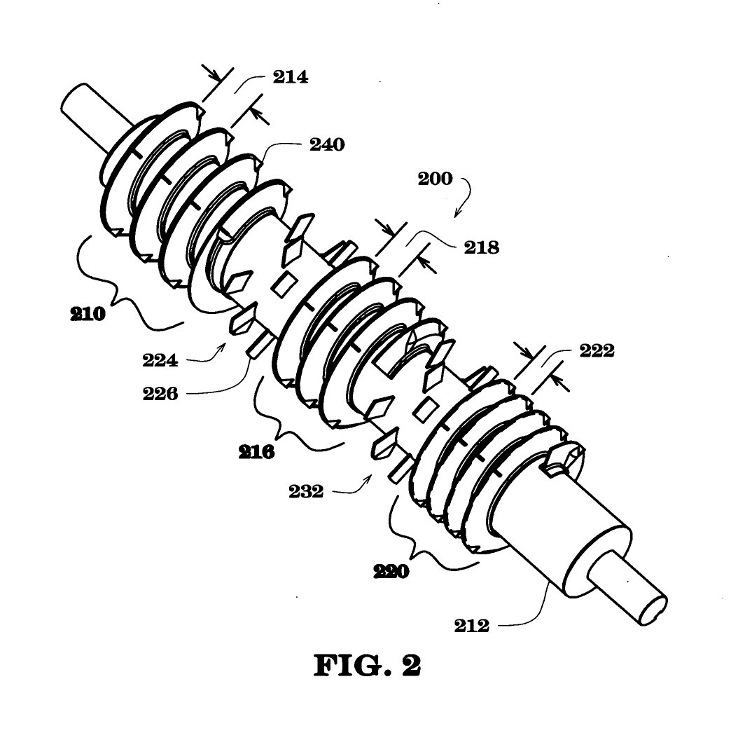

FIG. 2 shows an embodiment of a screw-type heat exchanger 200. A first flite section 210 is formed about a central stem pipe 212 having a fixed face flite with a fixed pitch 214 and shaped according to the design of FIG. 1. A second flite section 216 and a third flite section 220 are also formed about the stem pipe 212, each flite having a pitch 218 and 222 respectively. In this embodiment the pitch of each flite section is different wherein the first flite section pitch 214 by example is 5 inches, the second flite section pitch 218 is 4 inches and the third flite section pitch 222 is 3 inches. Each rotor segment is separated by a nonflite dead zone 224. The nonflite dead zone 224 is constructed with tabs 226 affixed radially to the stem pipe 212 extending approximately to the outer diameter of the flites 210. Each tab 226 may be positioned at a 90 degree or other such equal interval around the shaft. Further, particle relocation tabs are located on the flite itself 240.

The “Holo-Scru” processor, screw-type heat exchanger 200 operates by receiving a material into one end of the first flite section 210 and then rotating the rotor 210 such that the raw material product is conveyed by the flite 210 along the stem pipe 212. As the material moves out of the first flite rotor segment 210 it moves into a nonflite dead zone area 224 and is further agitated by the dead-zone section tabs 226 before proceeding along the second section of flite 216. In this embodiment the material passes along a second nonflite dead-zone section 232 before passing along the third section of flite 220. Each flite section is characterized by having a shorter pitch such that, when heating a material, if it shrinks volumetrically, it will still maintain close contact with all the flites surface area because the flite spacing, or pitch, is closer. The unique alternating design between flite section zones and non flite section dead zones, and non flite section dead zone tabs, allow for a maximum volume reduction for the apparatus footprint.

The embodiment shown 200 has three flite sections separated by two non-flite sections (e.g. “dead zone”) areas. One having skill in the art would recognize that they operate like a delta. Differing flite sections having differing pitches separated by differing non-flite sections coupled together in differing longitudes may be constructed to accommodate materials with differing volume reduction rates and heat transfer requirements and it is in the spirit of this invention to effect the same. These are the factors that determine the drying rate of the material.

The advantages of the current invention include more efficient heat transfer due to the shape and construction of the flites and the orientation of the flites to the material or product traveling axially along the shaft. This occurs because the flite maintains contact with the material longer due to the orientation of the curved edge of the second disk which faces in the direction of the material or product flow. In addition, the change in flite pitch sections will allow for increased material retention time for material or product. Further, the inner and outer diameter, coupled with the pitch in a given flite rotor section define an angle of helix as product is conveyed axially down the rotor assembly apparatus through a series of hollow cavity flite sections.

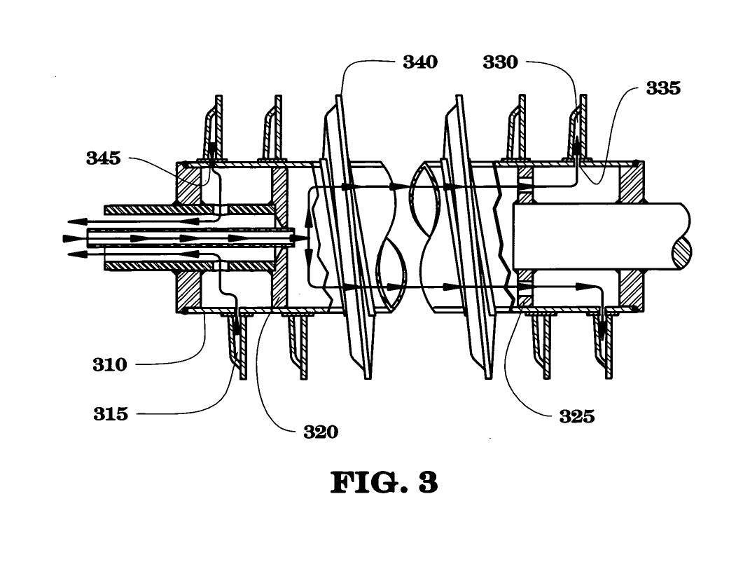

FIG. 3 illustrates the flow of the heat exchange medium through the stem pipe 310 and into the flite cavity 315. For this embodiment of the current invention the heat exchange medium enters the stem pipe 310 through the diverter plate 320. The heat exchange medium flows under pressure passing through a second diverter plate 325 near the end of the flite section. The heat exchange medium then enters the flite cavity 330 through a series of ports 335 in the stem pipe 310. The heat exchange medium then flows through the cavity 330 in the flite section 340 to the opposite end of the flite section. The heat exchange medium then exits the flite through a exit port 345 and enters the stem pipe. This process may be continued through multiple flite sections and allowing the heat transfer medium to pass into and out of differing flite sections heating the flites which will thermodynamically transfer heat to or from the material located between the flites.

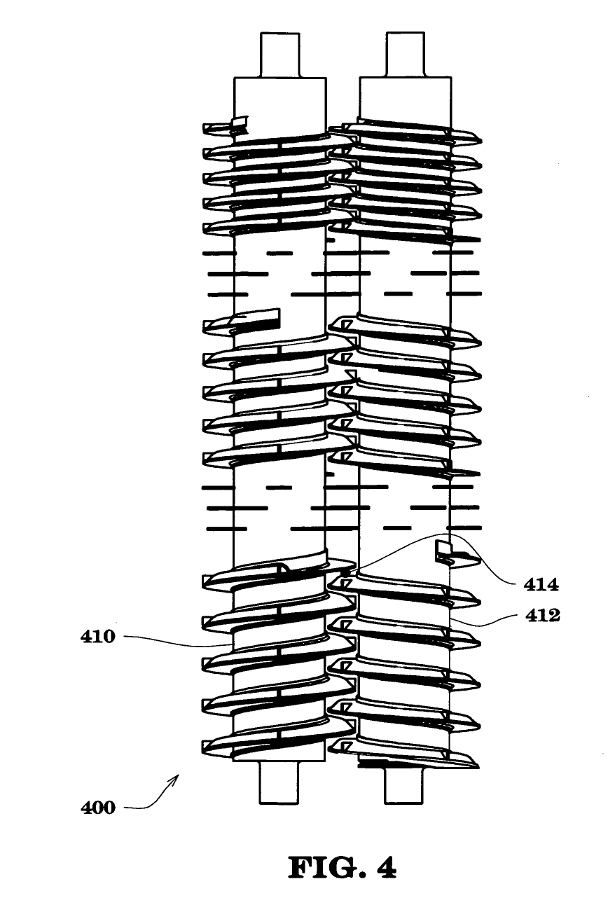

FIG. 4 illustrates another embodiment of the current invention using a twin rotor, a dual screw-type heat exchanger 400. In this embodiment, two screw-type heat exchangers are positioned such that the flites of a first screw-type heat exchanger 410 are intermeshing with the flites of a second screw-type heat exchanger 412. To realize this embodiment, the two heat exchanger rotors may be positioned alongside each other such that the material surges between the flites 414 of both heat exchanger rotors. The flites may be intermeshed with each other so that the outer diameter of each flite is spaced a short distance from the opposite rotor. Also, the angle of the flites may be adjusted to allow for more thermal contact, thereby increasing the thermal heat transfer per lineal foot. The heat transfer medium first moves through a rotary joint and into the hollow shaft of the rotor down the entire length of the assembly. It then turns into the helical outer portion of the new apparatus, returning through a series of hollow flites to the starting point. Two or four such units, intermeshing, are normally used. The assembly of the trough and screws, with suitable bearings, synchronizing gears, heat transfer medium connections and material inlet and outlet diverter plate ports, constitutes a dryer application.

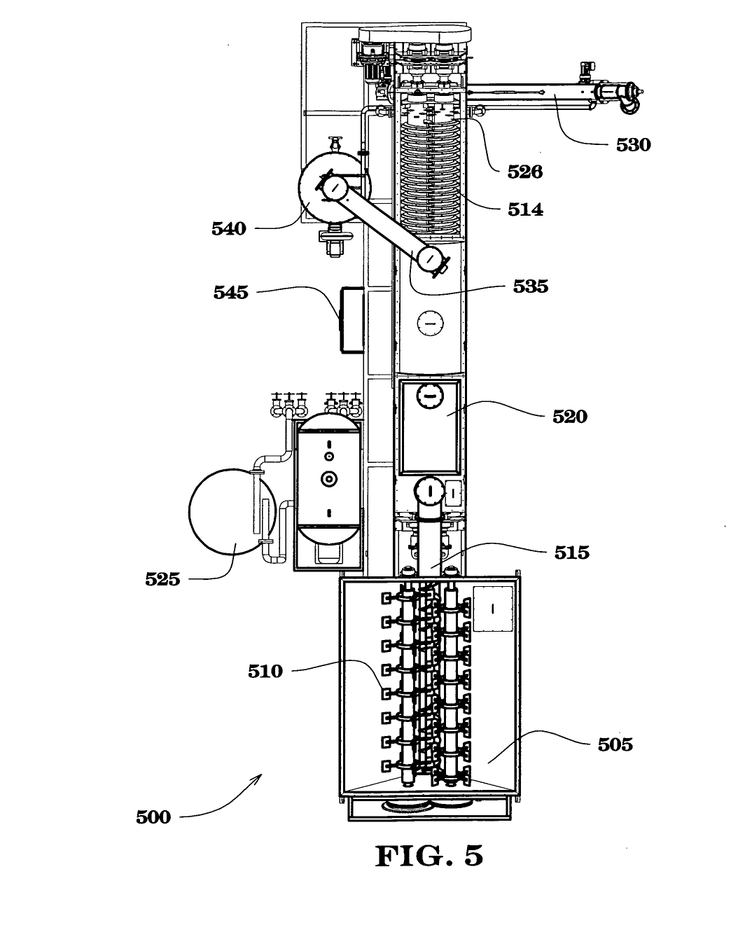

FIG. 5 illustrates an embodiment of a system 500 for drying materials or product. The system may include a bin or hopper 505 designed to temporarily hold material prior to processing with an internal breaker or blender 510 to homogenize the material. A transfer conveyor 515 may also be included to allow the homogenized material to be continuously fed from the bin or hopper 505 into a dual screw-type heat exchange sludge dryer 520. A thermal fluid heater 525 may then circulate a heating medium through the stem pipe 526, and or jacket 520 or flite blades 514. A dry discharge conveyor 530 may be included in the system to transfer the material product. An exhaust manifold 535 and a scrubber/condenser 540 may also be included. Finally, although the system is capable of hands free operation, a control panel 545 may be included to control the system's components.

In another embodiment, a heat exchange medium would enter the rotor apparatus via a rotary joint on a first end of the rotor and exit the apparatus on a second end of the rotor without returning to the first end to exit at the same place where it entered. In such a single pass design, the heat transfer medium, unlike in the previous embodiments, enters in a first end of the rotor apparatus and exits out a second end of the rotor apparatus to form a single pass of the heat transfer medium through one or more rotor segments comprising a fixed pitch and one or more non-flite dead zone regions to effect heat transfer of the product material being processed in the apparatus.

In another embodiment, a sludge dryer, continuously mixing, conveying, heating and cooling flowable materials apparatus system is disclosed. The system comprises a rotary joint assembly chamber, a trough, boiler, steam condenser, a processor, a feeder hopper, synchronizing gears, and a rotor assembly further comprising one or more rotor segments as disclosed above and one or more nonflite deadzone regions. The system is thermally coupled via thermocouples and connected to a programmable logic controller to maximize heat transfer and sludge volume reduction by providing a higher loading capacity through the length of the apparatus to accomplish a higher percentage of flite height fill and providing a higher percentage of usage of surface area of the rotors and apparatus in contact with product (material) being processed through the apparatus.

Another embodiment of the system may include a hopper or bin designed to temporarily hold materials prior to processing wherein the materials are homogenized and continuously fed into onto a transfer conveyor, at least one rotating screw heat exchange rotor having a plurality of flites, each flite having a different pitch from other flites, wherein the pitch encompasses the distance between flites. The flites are disposed along the rotor in a consistently spaced pitch with a dead-zone space wherein the flites are no longer spaced apart in a consistent pitch, the dead-zone space comprising no flites and separated from other flites spaced apart in an equal but different pitch, the second and subsequent pitch to create alternating zones of equal pitches and a “dead” zone area devoid of flites. Tabs in the dead-zone are disposed radially to a length not exceeding the dead-zone space, the tabs may be spaced 90 degrees off from the previous tab and equidistant from a point about a centerline through said shaft. Further, the system may include a device wherein the temperature of a heat transfer medium is increased and passed through a portion of the rotor or hollow blade in the flites, a product discharge conveyor for dry material discharge, a cylindrical chamber that has at least one outlet through which exhaust is released, a panel from which the system can be controlled including automated safety sensors and a device for reducing gasses or vapors to liquid or solid form (condenser). Several heat exchange shafts may then be arranged in space saving tiered units wherein heat sensitive products can be introduced into each tier individually at the desired temperature in order to avoid undesired chemical reactions. The system is also variously designed to thermally couple via thermocouples and connect to a programmable logic controller to maximize heat transfer and sludge volume reduction by providing a higher loading capacity through the length of the apparatus to accomplish a higher percentage of flite height fill and providing a higher percentage of surface area of the rotors and apparatus in contact with product (material) being processed through the apparatus. The system thereby achieves a compact floor plan per BTU rating.

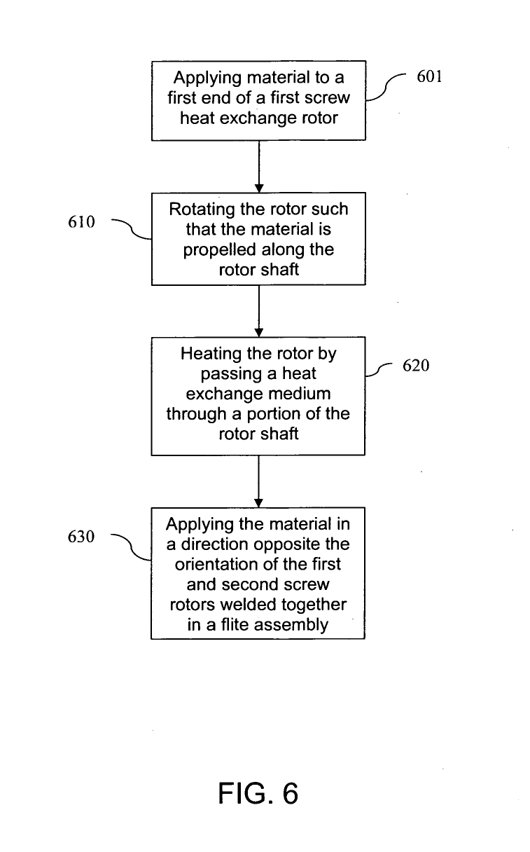

Another embodiment is illustrated in FIG. 6 wherein a method for drying a material comprises the following steps in any order: applying the material 601 to a first end of a first screw heat exchange rotor, said rotor having a plurality of flite sections, each flite section having a different pitch than the other flite sections; rotating the rotor such that a material is conveyed along the rotor 610; heating the rotor by passing a heat transfer medium through a portion of the rotor 620; and applying the material in a direction opposite the orientation of said first and second discs welded together in a flite assembly 630, wherein said applying the material increases heat transfer rates in the direction of material flow opposite to said first and second discs flite assembly, wherein said flite assembly comprises a back flite and a face flite, and wherein said back flite is facing the direction of material flow.

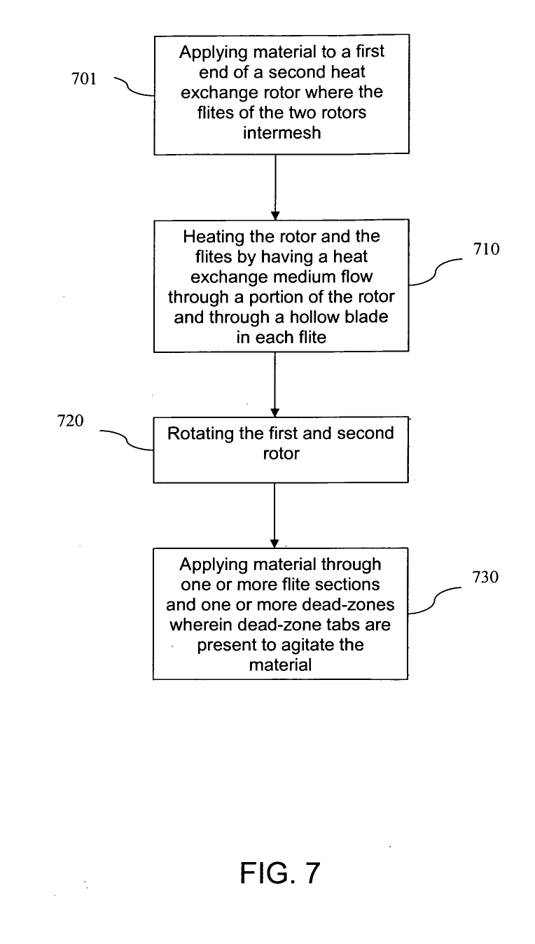

In certain aspects the embodiment as illustrated in FIG. 7 further comprises providing a second heat exchange rotor 701; applying the material to a first end of a second heat exchange rotor 701, said rotor being positioned in close proximity to the first heat exchange rotor such that the flites intermesh 701; heating the flites by having the heat transfer medium flow through a hollow flite assembly 710; rotating the second rotor 720; and applying the material through one or more flite sections and one or more dead-zones wherein said flite assemblies are not present but communicator non-flite dead zone tabs, ninety-degrees apart, are present to agitate said material 730.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An indirectly heated screw processor apparatus, comprising:
a housing;
at least one double-walled screw shaft; and
a hollow helical duct mounted on and surrounding said rotors, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the shaft, said curved disk oriented facing the direction of material flow, said discs spaced apart between said inner and outer edges to form a single continuous duct extending helically around the rotor and longitudinally along a rotor length, through which a heat transfer medium can flow within the hollow duct.

2. The apparatus of claim 1, further comprising:
one or more through-hole ports into the single continuous space wherein a heat transfer medium enters through said port, entering said single continuous helical duct and traversing the length of the rotor until exiting one or more through-hole ports per flite section.

3. The apparatus of claim 1, further comprising:
a pad upon which said first and second discs rest substantially radial to the shaft.

4. A screw heat exchange rotor, comprising:
a plurality of helical discs;
a shaft;
an entry port;
an exit port;
a mounting pad; and
a heat transfer medium,
wherein said screw heat exchange rotor is double walled and a hollow helical duct is mounted on and surrounding said rotor, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the rotor, said curved outer disk oriented facing the direction of material flow, said discs spaced apart between said inner and outer diameters to form a single continuous duct extending helically around the rotor and longitudinally along a rotor length, through which a heat transfer medium can flow within the hollow duct.

5. A rotating rotor assembly comprising:
a plurality of flite sections, each flite section having a different pitch from other flite sections, wherein said pitch comprises the distance between flite, said flites being spaced along the rotor in a consistently spaced pitch;
one or more dead-zone spaces wherein said dead-zone sections comprise no flites and are separated from other flite sections with a different pitch, said other pitch sections creating alternating zones of equal pitch sections and one or more “dead” zone sections; and
one or more tabs in said dead-zone sections extending radially and longitudinally to a length not to exceed the dead-zone section wherein some tabs are 90 degrees off from the previous tab, said tabs mounted equidistant from a point about a centerline through said shaft.

6. A multiple rotor heat exchange device comprising:
a housing;
a plurality of heat exchange rotors, each rotor having a plurality of flites, each flite having a different pitch, wherein each of the heat exchange shafts are positioned together such that adjacent flites intermesh, thereby increasing heat transfer rates and heat transfer capacities.

7. A method of drying a material comprising the following steps in any order:
applying the material to a first end of a first screw heat exchange rotor, said rotor having a plurality of flite sections, each flite section having a different pitch than the other flite sections;
rotating the rotor such that a material is conveyed along the rotor;
heating the rotor by passing a heat transfer medium through a portion of the rotor; and
applying the material in a direction opposite the orientation of said first and second discs welded together in a flite assembly, wherein said applying the material increases heat transfer rates in the direction of material flow opposite to said first and second discs flite assembly, wherein said flite assembly comprises a back flite and a face flite, and wherein said back flite is facing the direction of material flow.

8. The method of claim 7, further comprising:
providing a second heat exchange rotor;
applying the material to a first end of a second heat exchange rotor, said rotor being positioned in close proximity to the first heat exchange rotor such that the flites intermesh;
heating the flites by having the heat transfer medium flow through a hollow flite assembly;
rotating the second rotor; and
applying the material through one or more flite sections and one or more dead-zones wherein said flite assemblies are not present but communicator non-flite dead zone tabs, ninety-degrees apart, are present to agitate said material.

9. A system for drying material comprising
a bin designed to temporarily hold material prior to processing wherein said materials are homogenised and continuously fed onto a transfer conveyor;
at least one indirectly heated screw processor rotor having a plurality of flite sections, each flite section having a different pitch from other flite sections, wherein said pitch comprises the distance between flites, said flites being spaced along the rotor in a consistently spaced pitch;
a dead-zone space wherein said flites are no longer spaced apart in a consistent pitch, said dead-zone space comprising no flites and separated from other flites spaced apart in an equal but different pitch, said second and subsequent pitch to create alternating zones of equal pitches and a “dead” zone area devoid of flites, and tabs in said dead-zone disposed radially to a length not to exceed the dead-zone space, said tabs spaced 90 degrees off from the previous tab, said tabs equidistant from a point about a centreline through said shaft;
a hollow helical duct mounted on and surrounding said rotors, said hollow helical duct being made of pairs of helically shaped split discs, the first disc of each pair being substantially radial to the rotor, and the second disc being welded to the rotor at its inner diameter and having it's outer diameter curved towards the first disc and welded thereto at an outer diameter of the first disc such that substantially all of the remainder of the second disc is substantially radial to the shaft, said curved disk oriented facing the direction of material flow, said discs spaced apart between said inner and outer edges to form a single continuous duct extending helically around the rotor and longitudinally along a rotor length, through which a heat transfer medium can flow within the hollow duct,
a device wherein the temperature of a heat exchange medium is increased and passed through a portion of said rotoror hollow blade in said flites;
an exit port conveyor for dry material discharge;
a cylindrical chamber having at least one outlet through which exhaust is released;
a panel from which the system can be controlled including automated safety sensors; and
a device for reducing gases or vapors to liquid or solid form utilizing one or more scrubber design configurations.

10. The system of claim 9 further comprising
at least one rotating screw heat exchange rotor having a plurality of flites, each flite having a different pitch from other flite sections, wherein said pitch comprises the distance between flites, said flites being spaced along the rotor in a consistently spaced pitch; a dead-zone space wherein said flites are no longer spaced apart in a consistent pitch but is devoid of flites, said dead-zone space comprising no flites and separated from other flite sections spaced apart in an equal but different pitch, said second and subsequent pitch to create different pitches and tabs in said dead-zone configured longitudinally to a length not to exceed the dead-zone space, said tabs spaced 90 degrees off from the previous tab, said tabs equidistant from a point about a centerline through said rotor; wherein the rotating heat exchange rotors are arranged in space saving tiered units; and wherein heat sensitive products can be introduced into each tier individually at the desired temperature in order to avoid undesired chemical reactions.
